(19) United States
(12) Patent Application Publication
(10) Pub. No.: US 2026/0243589 A1
(43) Pub. Date: Aug. 20, 2026

(54) SENSOR FOR DETECTING A FLUID STREAM IN A FLUID LINE

(71) Applicant: KAUTEX TEXTRON GmbH & Co. KG, Bonn (DE)

(72) Inventors: René Erich MÜLLER, Bonn (DE); Sascha MEEVISSEN, Willich (DE); Thorsten LINDER, Bonn (DE); Florian WISCHELER, Koln (DE)

(21) Appl. No.: 18/870,330

(22) PCT Filed: May 30, 2023
(86) PCT No.: PCT/EP2023/064441

§ 371 Date: Nov. 27, 2024

(30) Foreign Application Priority Data
May 31, 2022 (DE) 10 2022 113 680.9

(51) Int. Cl. G01F 1/58; G01F 1/60; G01F 15/00

(52) U.S. Cl. CPC G01F 1/584; G01F 1/60; G01F 15/005

(57) ABSTRACT

The invention relates to a sensor for detecting a fluid stream in a fluid line, wherein the sensor includes a movable component that can be moved into a switching position by a fluid stream flowing through the sensor, in which position an electrical circuit is closed. The invention also relates to a system and to a method for detecting a malfunction in a fluid distribution system having a fluid line, using a sensor of this type.

This application is the U.S. National Stage entry of International Application No. PCT/EP2023/064441, filed on May 30, 2023, which, in turn, claims priority to DE Patent Application No. 10 2022 113 680.9, filed on May 31, 2022, both of which are hereby incorporated herein by reference in their entireties for all purposes.

The present invention relates to a sensor for detecting a fluid stream in a fluid line. The present invention also relates to a system and to a method for detecting a malfunction in a fluid distribution system. The present invention further relates to using the sensor or system according to the invention.

Motor vehicles typically have one or more fluid distribution systems by means of which fluids such as cleaning fluids or compressed air are distributed to multiple distribution points, such as cleaning points, of a motor vehicle. Examples of such fluid distribution systems, in particular fluid-based cleaning systems, include cleaning systems for the windshield of the motor vehicle or for sensors, such as cameras or LIDAR sensors, which are installed in motor vehicles for driver assistance. The number of such cleaning points in a motor vehicle to which fluids must be distributed will increase significantly in the future, particularly in the field of autonomous driving, as a large number of sensors are used here, the functionality of which must be ensured by adequate cleaning. Furthermore, fluid distribution systems are also becoming increasingly relevant for cooling batteries, especially traction batteries, of electrically powered motor vehicles, and for braking systems of motor vehicles.

In fluid distribution systems known from the prior art, the fluid to be distributed is usually distributed to the individual desired points of the motor vehicle via a distributor, such as a valve block, wherein the distributor is arranged downstream of, for example, a pump. It is also known to monitor the function of said pump in order, for example, to obtain feedback as to whether a cleaning operation is being carried out at a given time.

The present invention is based upon the object of enabling improved monitoring and/or control of a fluid distribution system, in particular a fluid distribution system which is arranged in a motor vehicle.

The object underlying the present invention is achieved by a sensor having the features of claim 1, a system according to claim 9, and a method according to claim 13. Further preferred embodiments are described in the dependent claims.

More specifically, the object underlying the present invention is achieved by a sensor for detecting a fluid stream in a fluid line, wherein the sensor has a housing with at least one fluid inlet and at least one fluid outlet, and wherein the fluid inlet and fluid outlet are fluidically connected to one another by at least one fluid channel. The sensor further has a movable component which is at least partially arranged in the fluid channel and which can be moved from a first position to a second position by a fluid stream flowing through the fluid channel. The first position and/or the second position is also a switching position in which an electrical circuit is closed.

Accordingly, an electrical circuit can be open in the first and preferred position, which is closed when the movable component moves to the second position. Or an electrical circuit can be closed in the first position, which is opened when the movable component moves to the second position. Or an electrical circuit can be closed in the first position, which is first opened and then closed again when the movable component moves to the second position. Or an electrical circuit can be closed in the first position, which is opened when the movable component moves to the second position, wherein another electrical circuit is closed. Depending upon the wiring, the sensor according to the invention can, in particular in combination with a computing unit described below, generate a sensor signal based upon an open or closed electrical circuit. This makes it possible to determine whether a fluid stream is flowing through the fluid channel of the sensor or not. In the further course of this application, solely for reasons of simplification and without excluding further possible combinations, reference is made to the case in which an electrical circuit is open in the first position of the sensor, which is closed when the movable component is moved by the fluid stream to the second position.

The fluid of the fluid stream can be any fluid, in particular a fluid which is used to operate a motor vehicle. Exemplary and preferred fluids according to the invention are operating fluids, such as SCR fluids or fuels, cleaning fluids, cooling fluids (coolants), and/or hydraulic fluids. The cleaning fluids can be cleaning fluids such as windshield washer fluids and/or cleaning fluids for cleaning vehicle sensors. The cleaning fluids can also, for example, be gaseous fluids, in particular air and/or compressed air. The coolants can, for example, be cooling fluids, in particular cooling fluids for cooling traction batteries. The hydraulic fluids can, for example, be a braking fluid.

The fluid stream can have a flow direction. The flow direction can in particular run from a fluid supply device, e.g., a pump or a compressor, e.g., in conjunction with an air reservoir, to at least one distribution point. The fluid stream is a fluid that is in motion.

The fluid line can be the fluid line of a motor vehicle. The fluid line can be intended for use in a pressure range of ≥−0.5 and ≤10 bar, preferably ≥−0.5 and ≤6 bar. Conversely, the fluid line can be characterized in that it is unsuitable for use at a pressure above 10 bar and/or would be damaged. The fluid line can be made of a plastic; the fluid line can, in particular, be a plastic hose. The fluid line can be selected from the group consisting of brake fluid line, cleaning fluid line, coolant fluid line, compressed air line, operating fluid line, and fuel line.

The housing of the sensor according to the invention has a wall and encloses an interior, which can also be referred to as the volume of the housing. The wall of the housing has a side which faces the interior and can be referred to as the inside. The wall of the housing further has a side which faces away from the interior and can be referred to as the outside or as facing the surroundings. The wall of the housing is penetrated by the fluid inlet or the fluid outlet. In other words, fluid inlet and fluid outlet represent openings in the wall of the sensor housing.

The fluid inlet and fluid outlet of the sensor according to the invention are fluidically connected to one another by at least one fluid channel. The fluid inlet and/or fluid outlet can be configured to be connected to a fluid line. The fluid inlet and/or fluid outlet can be connected to a fluid line.

A fluid flowing from the fluid inlet to the fluid outlet of the sensor according to the invention via the at least one fluid channel can be referred to as a fluid stream with a flow direction from the fluid inlet to the fluid outlet and/or as a fluid stream with a flow direction along the fluid channel through which it flows.

The movable component of the sensor according to the invention is at least partially arranged in the fluid channel. It can also be partially or completely arranged within the sensor housing. The movable component can be guided at least in sections or completely when transitioning from the first position to the second position. Preferably, such guidance can be achieved by the housing wall, in particular its inside. Alternatively or additionally, guidance can also be provided by a region of the movable component-for example, when a region of the movable component engages in a recess in the housing wall of the sensor. Further preferably, the contact surface for closing the electrical circuit can be arranged on said region, serving as a guide, of the movable component. Also preferably, the region, serving as a guide, of the movable component can engage in the recess already in the position in which the electrical circuit is open. The contact surface of the movable component can be arranged outside the recess.

Because the movable component is at least partially arranged in the fluid channel, it can be contacted and actuated by the fluid stream which flows through the fluid channel with a flow direction along the fluid channel. The movable component can be moved from a first position to a second position.

The first position and/or the second position into which the movable component can be moved by a fluid stream flowing through the fluid channel corresponds to a switching position of the sensor and/or of the movable component in which an electrical circuit is closed. In other words, the sensor according to the invention can also be referred to as a switch which can be actuated by a fluid stream flowing through the fluid channel. It can, in particular, be a single-pole switch where the electrical connection can be either open or closed (“on-off switch”). However, it can also, for example, be a single-pole changeover switch (“on-on switch”), in which an electrical circuit is closed in each switching position. Opening and/or closing the electrical circuit can further be suitable for generating a sensor signal, or it can generate a sensor signal. When closing the electrical circuit, a galvanic connection is preferably established. When opening the electrical circuit, a galvanic connection is preferably interrupted.

Preferably, the electrical circuit can be open in the first position of the movable component, whereas the electrical circuit is closed in the second position of the movable component. Further preferably, an electrical circuit can be closed in the first and second positions of the movable component, wherein the electrical circuit can be a single circuit or two separate circuits. Also preferably, the electrical circuit can be closed in the first position of the movable component, whereas the electrical circuit is open in the second position of the movable component.

The positions of the movable component, i.e., the first position and/or the second position, can be end positions of the movable component. An end position of the movable component can be achieved by the movable component contacting a stop in the end position. The stop can preferably be formed by the housing of the sensor, in particular the wall of the housing of the sensor, in particular the surface, facing the interior, of the housing of the sensor. The stop, in particular the stop in the open and/or first position of the movable component, can be the valve seat of a fluid valve.

The movable component can be connected directly or indirectly to the housing of the sensor at least at one point. Such connection of the movable component to the housing of the sensor is understood to mean that the component in its first position, in its second position, and when transitioning from the first to the second position is directly or indirectly connected to the housing of the sensor. Such connection of the movable component to the housing of the sensor can also be referred to as an irreversible connection.

Where a connection between the movable component and the housing is discussed below, both an indirect and a direct connection thereof is always intended to be disclosed.

Alternatively, in contrast, the movable component may not be directly or indirectly connected to the housing of the sensor. In that case, the movable component may have no contact with the housing of the sensor, at least temporarily, in particular when transitioning from the first position to the second position. This does not exclude the possibility of the movable component in the first position and/or in the second position directly or indirectly contacting the housing of the sensor. Such a connection of the movable component to the housing of the sensor can also be referred to as a reversible connection.

In particular, the movable component can be irreversibly connected to the wall and/or the inside of the wall of the housing. This is advantageous, in particular, if the movable component can be moved from the first position to the second position via a rotation. Particularly preferably, the movable component can be connected to the housing of the sensor via an axis and can be moved about said axis from the first position to the second position. Preferably, the axis can be arranged in the interior of the housing. Further preferably, the axis can be connected to the wall of the housing and/or the inside of the wall of the housing.

The movable component can also be irreversibly connected to the housing, preferably the wall of the housing, via a spring. As will be explained further below, the movable component can be connected in particular to the inside of the wall of the housing by means of the spring. If the movable component is connected to the housing via a spring, the spring can be either biased or unbiased in the position of the sensor in which an electrical circuit is closed.

In the event that the movable component is not directly or indirectly connected to the housing of the sensor, i.e., in the case of a reversible connection, the movable component is advantageously guided at least while transitioning from its first position to its second position. Such guidance of the movable component can preferably be carried out via the housing wall or a guide connected to the housing wall. As will be explained further below, translatorily movable valve bodies and/or spherically-shaped valve bodies are particularly preferred examples of reversibly connected, movable components.

As previously described, the movable component can be moved translatorily and/or rotationally by the fluid stream. Further preferably, translatorily movable components can be guided and/or reversibly connected to the housing of the sensor. During the translatory movement of the movable component, the latter can be raised by the fluid stream. In other words, the translatory movement of the movable component can also be referred to as raising the movable component. Further preferably, rotationally movable components can be irreversibly connected to the housing of the sensor via an axis, wherein the axis can be arranged in particular in the interior of the housing. The translatory movement of the movable component can preferably take place in a direction of movement which is arranged substantially at a right angle to the flow direction of the fluid through the flow channel. In the case of a rotationally movable component, the axis can preferably be arranged substantially at a right angle to the flow direction of the fluid through the flow channel.

The sensor according to the invention can be configured as a fluid valve, wherein the movable part of the sensor according to the invention can be a shut-off body of the fluid valve. The housing of the sensor according to the invention can correspond to the valve housing of the fluid valve. The shut-off body can preferably be arranged at least partially in the interior of the housing of the sensor. The fluid valve can, in particular, be a valve for fluids or for compressed air. The sensor according to the invention can, as a fluid valve, be selected from the group consisting of a check valve, a check valve with a check flap as a valve body, a check valve with a ball as a valve body, a check valve with a cylinder as a valve body, a pressure valve, a unidirectional pressure valve, a bidirectional pressure valve, a unidirectional check valve, and a bidirectional check valve.

The sensor according to the invention can be made at least partially from a plastic. Preferably, at least the housing of the sensor according to the invention consists at least partially, preferably substantially completely, of a plastic. This makes it easier to connect the sensor to a fluid line that is also made of plastic.

Preferably, the sensor can be configured as a check valve, in particular for liquids. The movable part or shut-off body of the check valve can be a check flap, a cylinder, a piston, or a ball. The check flap can be connected directly or indirectly to the housing of the check valve via an axis and can be moved in a rotational manner. The axis can be arranged in the interior of the housing. The ball can either be connected to the valve housing via a spring or not connected to the valve housing. If the ball is not connected to the housing of the valve, it can be guided, preferably via the housing wall. Balls, cylinders, and pistons can, in particular, be movable in a translatory manner. The translatory movement can take place parallel or substantially perpendicular to the flow direction of the fluid stream.

Also preferably, the sensor can be configured as a pressure valve, in particular as a pressure switch valve. The pressure valve can preferably be a pressure valve for compressed air. The movable part or shut-off body of the pressure valve can be a ball, a cylinder, or a piston, which is preferably movable in a translatory manner. The translatory movement can take place parallel or substantially perpendicular to the flow direction of the fluid stream. The shut-off body can either be connected to the valve housing via a spring or not connected to the valve housing.

The sensor according to the invention can have at least two electrodes, wherein the electrodes are contacted in the switching position of the sensor in which the electrical circuit is closed. Conversely, the electrodes are not contacted in the switching position of the sensor in which the electrical circuit is open. The electrodes can therefore also be referred to as the contacts of a switch.

The electrodes can be contacted directly or indirectly through the movable component. In case of direct contact, the movable component can directly contact at least one electrode or two electrodes. In case of indirect contact, the movable component can be brought into contact with a contact device, which in turn contacts the at least two electrodes and thus closes the electrical circuit. For this purpose, the contact device can be formed at least in sections from an electrically conductive material, preferably metal. The contact device can be spring-biased. This can prevent contact of the electrode or electrodes when the movable component is not abutting. Particularly preferably, the contact device and the at least two electrodes can be encapsulated in order to prevent contact of the electrodes with the fluid. Also advantageously, the contact device encapsulated together with the electrodes can be arranged at least partially in the interior of the sensor.

During contact, the electrodes are preferably electrically contacted and/or galvanically connected to one another. In other words, by the contact of the at least two electrodes, the electrical circuit of the sensor according to the invention is closed and/or a sensor signal is generated. The electrodes can be electrically contactable outside the housing of the sensor according to the invention. In particular, the electrodes can have at least one electrical line, such as a single-core or a two-core cable, via which they can be electrically contacted outside the housing of the sensor.

The electrodes can each have at least one electrically conductive contact surface via which the electrical contact is made. The movable component can have an electrically conductive contact surface via which the electrical contact of the at least two electrodes is made.

The at least two electrodes can be structurally separate from the movable component of the sensor or can be independent components of the sensor according to the invention. Alternatively, one of the at least two electrodes can be integrated into the movable component, wherein the second of the at least two electrodes is a component, separate from the movable component, of the sensor. Preferably, the at least two electrodes are components separate from the movable component. This ensures that the electrodes can be more easily replaced and/or serviced without having to access the movable component.

The at least two electrodes can be directly or indirectly connected to the housing of the sensor. Preferably, the two electrodes can be directly or indirectly connected to the housing wall of the sensor. The at least two electrodes can at least partially protrude into the interior of the sensor according to the invention, in particular with their electrically conductive contact surfaces.

Preferably, particularly with liquid fluids, it is provided that both electrodes or their contact surfaces not be able to come into contact with the fluid at the same time. This effectively prevents short circuits. Particularly preferably, one, even more preferably both, electrodes, or their contact surface, cannot be contacted by the fluid. Further preferably, at least one electrode, even more preferably both electrodes, are connected to or integrated into the housing wall in such a way that their electrically conductive contact surface does not protrude into the interior of the sensor or is arranged within the housing wall. The electrically conductive contact surface of the movable component can then engage in a recess in the housing wall to contact the electrodes. If one or both electrodes with their electrically conductive contact surfaces protrude into the interior of the sensor according to the invention, they can protrude into a fluid-protected or substantially fluid-free sub-volume of the interior of the sensor. This sub-volume can have a wall with an opening through which the movable component extends. This ensures that the electrodes are contacted by the movable part in the absence of the fluid. The opening can in particular have the shape of a slot. Furthermore, the opening can be sealed against the fluid-for example, by a seal such as a rubber or plastic seal. The opening or slot can advantageously be used to guide the movable component.

The movable component can have at least one contact surface for closing the electrical circuit. Preferably, said contact surface is an electrically conductive contact surface and is arranged on the shut-off body of a fluid valve in such a way that the contact surface is not in contact with the fluid at least in the switching position of the sensor in which the electrical circuit is open. Alternatively or additionally, the contact surface can be substantially not in contact with the fluid in the switching position of the sensor in which the electrical circuit is closed. In other words, the contact surface on the shut-off body of the fluid valve is not in contact with the fluid, at least when the valve is closed, which fluid flows through the sensor when the valve is open. This has the advantage that the contact time between contact surface and fluid is minimized, and a more reliable switching of the sensor is ensured. The contact surface can be arranged on the side of the shut-off body which is opposite the fluid outlet of the sensor according to the invention. The contact surface can be arranged on the side of the shut-off body which, when the valve is closed and along the flow direction of the fluid, is closer to the fluid outlet than to the fluid inlet.

Preferably, the sensor according to the invention is a check valve, wherein the contact surface is arranged on the check flap, in particular on the side, opposite the fluid outlet, of the check flap. Due to the rotational movement of the check flap, electrical contact is made with two electrodes via the contact surface of the check flap, wherein at least one, preferably both, of these electrodes are structurally separate from the movable component of the sensor and are preferably connected to the housing wall of the sensor. Furthermore, the contact surface(s) of the electrode(s) is/are arranged in the interior of the sensor according to the invention. This closes an electrical circuit and/or generates a sensor signal.

Also preferably, the sensor according to the invention is a check valve, wherein the contact surface is arranged in the region of the axis connection of the check flap with the sensor housing. Preferably, the region of the axis connection is an end region of the check flap. The region of the axis connection is preferably arranged in the interior of the sensor such that it lies substantially outside the fluid stream of the fluid. Due to the rotational movement of the check flap, electrical contact is made with two electrodes via the contact surface of the check flap, wherein at least one, preferably both, of these electrodes are structurally separate from the movable component of the sensor and are preferably connected to the housing wall of the sensor. Furthermore, the contact surface(s) of the electrode(s) is/are arranged in the interior of the sensor according to the invention. This closes an electrical circuit and/or generates a sensor signal. Such an embodiment has the further advantage that the contact surface in the region of the axis connection substantially does not come into contact with the fluid both when the valve is closed and when it is open.

Also preferably, the sensor according to the invention is a check valve or pressure valve, wherein the contact surface is arranged on the side of the shut-off body which, when the valve is closed and along the flow direction of the fluid, is closer to the fluid outlet than to the fluid inlet. The shut-off body is preferably a cylinder or piston that can be moved in a translatory manner. Due to the translatory movement of the shut-off body, electrical contact is made with two electrodes via its contact surface, wherein at least one, preferably both, of these electrodes are structurally separate from the movable component of the sensor and are preferably connected to the housing wall of the sensor. Furthermore, the contact surface(s) of the electrode(s) is/are arranged in the interior of the sensor according to the invention. This closes an electrical circuit and/or generates a sensor signal.

At least one, preferably at least two, electrodes of the sensor according to the invention can be or are connected to a computing unit. The connection can be made via the electrical cable described above with reference to the electrodes. At least one of the two electrodes can be or is connected to the data input of the computing unit. The computing unit can be a control unit and/or an electronic control unit (ECU), preferably a control unit and/or an ECU of a motor vehicle.

The object underlying the present invention is also achieved by a system for detecting a fluid stream in a fluid line according to claim 9. The system can also be referred to as a fluid distribution system and in particular as a fluid distribution system for a motor vehicle. The system according to the invention can have the sensor according to the invention as a component. Accordingly, the above disclosure regarding the sensor according to the invention also applies to the following disclosure of the system according to the invention.

The system according to the invention has a fluid supply device and a first fluid line with at least one inlet opening and at least one outlet opening. The first fluid line is fluidically connected to the fluid supply device. The fluid supply device of the system according to the invention is suitable and/or configured to generate a fluid stream from the fluid supply device to the outlet opening of the first fluid line.

The system according to the invention further has a first sensor for detecting the fluid stream in the first fluid line, wherein the sensor is arranged on and/or at least partially in the first fluid line. Particularly preferably, the sensor is arranged on and/or at least partially in a region of the first fluid line which corresponds to an end region of said fluid line. Further preferably, the end region of the fluid line is the region of the inlet opening and/or outlet opening of the fluid line. This advantageously ensures that the fluid stream can be detected in the vicinity of the inlet opening and/or outlet opening of the fluid line. An arrangement of the sensor in the region of the outlet opening of the fluid line, in particular in the region of a distribution point of the motor vehicle arranged here, such as a nozzle or the distribution points mentioned below, is particularly preferred. The sensor according to the invention can also be integrated into the distribution point; the sensor can, in particular, be integrated into a distribution point configured as a nozzle.

The fluid supply device can be any suitable fluid supply device. The fluid supply device is preferably a pump or a compressor; further preferably, it is an electrically or mechanically driven fluid supply device. The pump can be selected from the group consisting of a water pump, a coolant pump, an operating fluid pump, a fuel pump, a cleaning fluid pump, a multi-way pump, in particular a two-way pump, and a hydraulic pump. The compressor can preferably be an air compressor or a fan for ambient air.

The system according to the invention can further have a tank which is fluidically connected to the fluid supply device. The tank can in particular be a tank for fluids or liquids such as water, detergents, operating fluids, or fuel. The tank can also be an air reservoir for storing compressed air. The fluid stream generated by the fluid supply device runs from the tank either directly through the first fluid line in the direction of the outlet opening of the first fluid line, or runs first through the fluid supply device and then through the first fluid line and in the direction of the outlet opening of the first fluid line. The tank can be fluidically connected to the fluid supply device via a supply line. The first sensor for detecting the fluid stream in the supply line can be arranged on and/or preferably at least partially in said supply line. The sensor is preferably a sensor according to the invention.

As regards the first fluid line of the system according to the invention, reference is made to the above. The fluid line can have several segments that are fluidically connected to one another. While the inlet opening of the first fluid line upstream of the fluid stream is fluidically connected to the fluid supply device, the outlet opening of the first fluid line downstream of the fluid stream can be fluidically connected to any distribution point, in particular of a motor vehicle. Such distribution point can also be referred to as a fluid receiver. The fluid receiver can be selected from the group consisting of a cleaning point of a motor vehicle, such as a nozzle, in particular a cleaning fluid nozzle or compressed air nozzle, a brake cylinder, a cooler, and a cooling device of a traction battery.

The first sensor of the system according to the invention can be any suitable sensor for detecting the fluid stream in the first fluid line. Exemplary suitable sensors include acoustic sensors, such as microphones or ultrasonic sensors, and/or flow sensors. Particularly preferably, the first sensor of the system according to the invention is the previously described sensor according to the invention for detecting the fluid stream in a fluid line.

The first sensor can preferably be arranged between the inlet opening of the fluid line and the outlet opening of the fluid line, viewed in the direction of the fluid stream through the first fluid line.

The first sensor of the system according to the invention is arranged on and/or in the first fluid line. For example, acoustic sensors, such as microphones, are preferably arranged on the first fluid line. In other words, such sensors are arranged outside the first fluid line and preferentially contact the latter.

The first sensor of the system according to the invention, in particular if it is the above-described sensor according to the invention, is preferably arranged at least partially in the first fluid line. This means that the fluid stream through the first fluid line runs in sections through the sensor according to the invention. For this purpose, the first fluid line can consist of at least two segments, each of which has an inlet opening and an outlet opening. In other words, the first fluid line can be interrupted by the sensor arranged in the first fluid line, resulting in the two segments of the fluid line. The inlet opening of the first segment is arranged closest to the fluid supply device in the direction of the fluid stream, while the outlet opening of the second segment is arranged furthest away from the fluid supply device in the direction of the fluid stream. The sensor is fluidically connected, in particular attached, via its fluid inlet to the outlet opening of the first segment. The sensor is fluidically connected, in particular attached, via its fluid outlet to the inlet opening of the second segment. The sensor is thus fluidically connected upstream of the fluid stream to the fluid supply device and is fluidically connected downstream of the fluid stream to the outlet opening of the first fluid line.

Hereafter, a sensor arranged in the fluid line will be discussed. Unless otherwise stated and technically reasonable, this shall always refer to both a sensor arranged partially in the fluid line and a sensor arranged on the fluid line.

The system according to the invention can further have at least one computing unit, e.g., an ECU, wherein said computing unit is connected to at least the first sensor in the first fluid line, and can additionally have a second fluid line, which also has at least one inlet opening and at least one outlet opening, and which is also fluidically connected to the fluid supply device.

The computing unit can further be connected to the fluid supply device. In particular, the computing unit can be configured to generate, evaluate, and/or send a fluid supply request to the fluid supply device. By sending a fluid supply request to the fluid supply device, the fluid supply device can be activated to convey the fluid. A fluid supply request can be generated, for example, when the user of the motor vehicle actuates an actuator, such as a switch, to generate the fluid supply request. For this purpose, the actuator mentioned can be connected to the computing unit, and/or actuation of the actuator can be evaluated by the computing unit. The fluid supply request can also be generated automatically or without any intervention by the user of the motor vehicle. For example, for this purpose, the computing unit can be configured to generate a fluid supply request if certain operating parameters of the motor vehicle are present. For example, a fluid supply request for supplying cleaning fluid can be generated by the computing unit when determining that the windshield and/or at least one sensor of the motor vehicle is dirty.

The system according to the invention can further have a fluid distribution unit arranged between the fluid supply device and/or a tank fluidically connected thereto and the inlet opening of the first fluid line and the inlet opening of the second fluid line. The fluid distribution unit is fluidically connected to the fluid supply device-for example, via at least one supply line between the fluid supply device and the fluid distribution unit. The first sensor for detecting the fluid stream in the supply line can be arranged on and/or preferably at least partially in said supply line. In that case, the fluid distribution unit is particularly preferably a fluid distribution unit for a gaseous fluid, in particular compressed air. The sensor is preferably a sensor according to the invention. The fluid distribution unit can be connected to and/or controlled by the computing unit.

The fluid distribution unit can preferably be a valve block, in particular a valve block of a motor vehicle. Furthermore, the fluid distribution unit, in particular the valve block, can have at least one fluid inlet via which the fluid distribution unit is fluidically connected to the fluid supply device. The fluid distribution unit, in particular the valve block, can further have at least two, at least three, at least four, at least five, at least eight, or at least ten fluid outlets via which the fluid distribution unit is fluidically connected to the first and a corresponding number of further fluid lines. In other words, the first and the further fluid lines of the system according to the invention can be connected at the fluid outlets of the fluid distribution unit. The fluid outlets of the fluid distribution unit can be controlled individually or jointly to allow or prevent a fluid flow through a specific fluid outlet. The control operation can take place via a computing unit, for example.

The computing unit can also be connected to the fluid distribution unit. In particular, the computing unit can be configured to send a fluid supply request for fluid supply in at least one of the fluid lines connected to the fluid distribution unit. By sending such a fluid supply request to the fluid distribution unit, fluid supply can be controlled in a specific fluid line.

The computing unit can also be connected to at least one distribution point, in particular a distribution point at the outlet opening of a fluid line. In particular, the computing unit can be configured to query or detect the activatability, activation, status, and/or proper functioning of the distribution point. Distribution points, such as cleaning points for the windshield washer system and/or cleaning points for the cleaning of sensors, often have actuators. Such actuators can provide information about their status, such as the status of proper functioning and/or the status of malfunction. Furthermore, information can be provided about whether the actuator can be activated or is currently activated. All this information can be sent from the distribution point to the computing unit for further processing, or can be queried by the latter.

Preferably, a second sensor for detecting the fluid stream in the second fluid line is arranged in the second fluid line. As regards said second sensor, the same statements as previously made about the first sensor apply; in particular, the second sensor is again a previously described sensor according to the invention. The computing unit of the system according to the invention can also be connected, in particular as described above, to the second sensor in the second fluid line.

The system according to the invention can have any number of additional fluid lines. They are preferably also connected to the fluid distribution unit. Also, another sensor for detecting the fluid stream can be arranged in each additional one of these fluid lines. Preferably, such a sensor is arranged in each fluid line, in particular in each fluid line that is connected to the fluid distribution unit. Particularly preferably, the system according to the invention has at least three, at least four, at least five, at least eight, or at least ten such fluid lines, in each of which a sensor for detecting the fluid stream is arranged.

The system according to the invention can further be configured to carry out the method described below for detecting malfunctions in a fluid distribution system. In particular, the control unit of the system according to the invention can be configured to carry out the method described below for detecting malfunctions in a fluid distribution system.

Furthermore, the present invention relates to a method for detecting a malfunction in a fluid distribution system according to independent claim 13. The fluid distribution system can in particular be the above-described system according to the invention.

The method according to the invention can be a method for detecting a malfunction in a fluid distribution system, wherein the fluid distribution system has a fluid supply device, at least one first fluid line with at least one inlet opening and at least one outlet opening, wherein the first fluid line is fluidically connected to the fluid supply device. The fluid supply device is furthermore suitable for generating a fluid stream from the fluid supply device to the outlet opening of the first fluid line, and the fluid distribution system has a first sensor for detecting the fluid stream in the first fluid line, wherein the sensor is arranged on and/or at least partially in the first fluid line. The fluid distribution system further has a computing unit, wherein the computing unit is connected to at least the first sensor. The method can have the two steps of:
a1) detecting a fluid stream in the first fluid line by means of the first sensor, and
b1) detecting a malfunction if a fluid stream has been detected in step a1) although there is no fluid supply request for the first fluid line, or if no fluid stream has been detected in step a1) although there is a fluid supply request for the first fluid line.

A core idea of the method according to the invention is to detect the actual fluid stream in a fluid line (step a1) and to compare it with whether there is a fluid supply request for this fluid line for the fluid distribution system (step b1). If a discrepancy is detected between the actual fluid stream in a fluid line and the presence or absence of a fluid supply request for said fluid line, it means that there is a malfunction in the fluid distribution system.

The method according to the invention can be repeated cyclically. The method according to the invention can also be initiated by an event or executed when such an event occurs. An exemplary event is the generation of a fluid supply request. Another exemplary event is the start or operation of a fluid supply device of the motor vehicle. Another exemplary event is the start or operation of the windshield wipers of the motor vehicle.

If, for example, a fluid stream is detected in a fluid line although there is no fluid supply request for said fluid line, the malfunction may be an undesired or unwanted cleaning operation and/or an unwanted priming operation and/or a fluid leak in the line in question. The “priming” of fluid lines is an operation known to those skilled in the art in which the fluid lines are filled with fluid, e.g., a liquid or compressed air, before the fluid is required to be removed. Accordingly, the method according to the invention can also be referred to as a method for detecting an unwanted cleaning operation and/or an unwanted priming operation and/or a fluid leak and/or a faulty control of the fluid distribution system, in particular of a fluid distribution unit of such a fluid distribution system. The method according to the invention can also be used to detect the completion of a priming operation. First, a fluid stream is detected in a fluid line under consideration, which can no longer be detected after a certain time despite the fluid supply device being activated. At the second point in time, the fluid “is stationary” in the line, and the priming operation is complete.

If, for example, no fluid stream is detected in a fluid line although there is a fluid supply request for said fluid line, the malfunction may be a defective and/or blocked/clogged distribution point-for example, a defective actuator and/or a defective cleaning point. The malfunction can also be a clogged or leaking fluid line. Accordingly, the method according to the invention can also be referred to as a method for detecting a defective and/or blocked/clogged distribution point-for example, a defective actuator and/or a defective cleaning point. It can also be referred to as a method for detecting a defective distribution point and/or a clogged or leaking fluid line.

Preferably, in the event that no fluid stream has been detected in step b1) although there is a fluid supply request, the method according to the invention can additionally have the further steps of:
b2) detecting the proper functioning of a distribution point at the outlet opening of the first fluid line; and
b3) detecting a blockage and/or a fluid leak in the first fluid line if proper functioning of the distribution point has been detected in step b2); or detecting a malfunction of the distribution point if no proper functioning of the distribution point has been detected in step b2).

The method according to the invention can thus be referred to as a method for detecting a blockage and/or a fluid leak in a fluid line of a fluid distribution system and/or as a method for detecting a malfunction of a distribution point of a fluid distribution system.

The method according to the invention can also be carried out when a fluid supply request has been generated-for example, by the computing unit. The method according to the invention can also be carried out if a fluid stream in the first fluid line has been detected by means of the sensor.

The present invention further relates to a motor vehicle having a sensor according to the invention and/or a system according to the invention, and/or to a motor vehicle which is configured to carry out the method according to the invention. The motor vehicle can preferably be an autonomous motor vehicle.

The present invention further relates to the use of a sensor according to the invention and/or of the system according to the invention for detecting a fluid stream in a fluid line and/or for carrying out the method according to the invention.

Further advantages, details, and features of the invention can be found below in the described exemplary embodiments. In the figures, in detail:

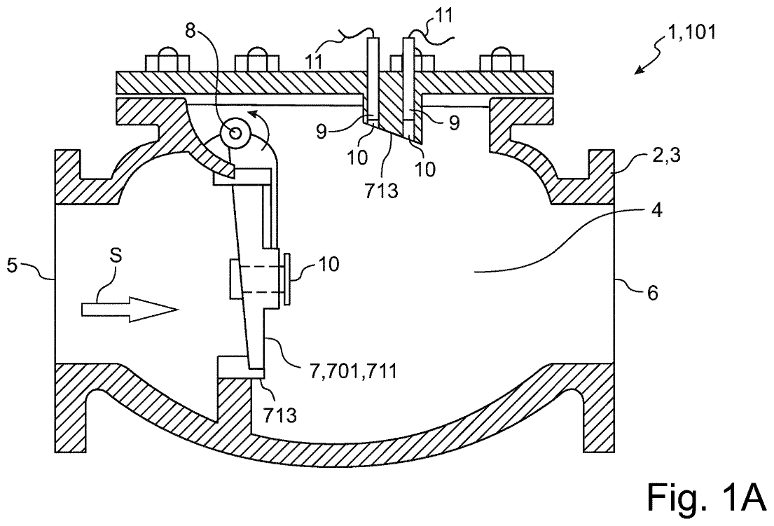

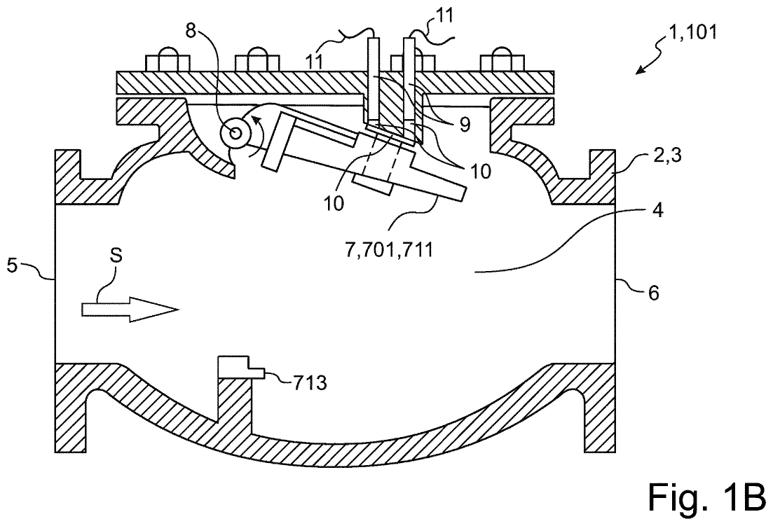

FIG. 1A shows a schematic representation of a first embodiment of the sensor according to the invention, which is configured as a check valve and shown at the first position of the movable component.

FIG. 1B shows a schematic representation of a first embodiment of the sensor according to the invention, which is configured as a check valve and shown at the second position of the movable component, which can be achieved by rotating the movable component.

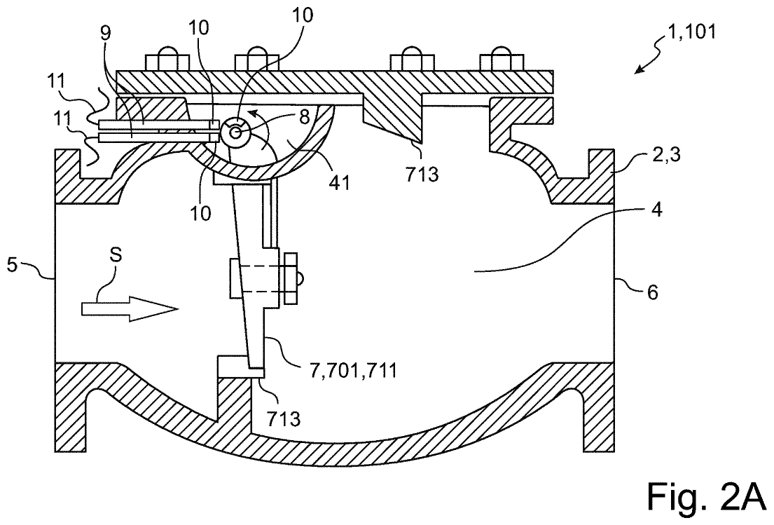

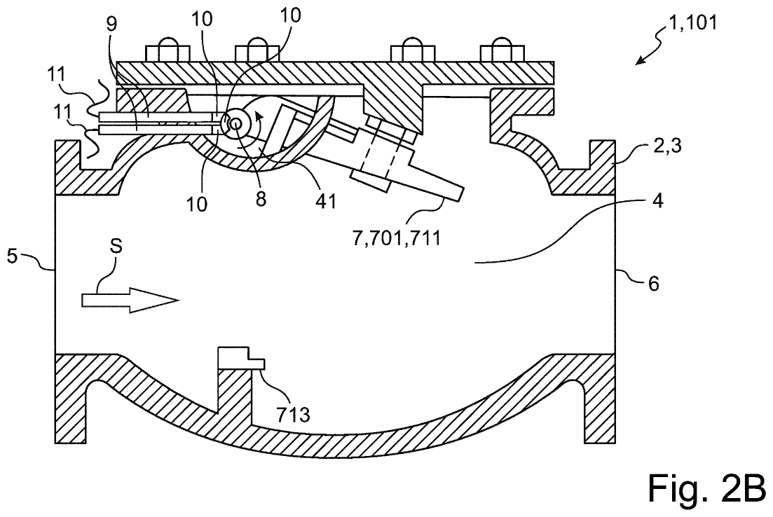

FIG. 2A shows a schematic representation of another embodiment of the sensor according to the invention, which is configured as a check valve and shown the first position of the movable component.

FIG. 2B a schematic representation of another embodiment of the sensor according to the invention, which is configured as a check valve and shown at the second position of the movable component, which can be achieved by rotating the movable component.

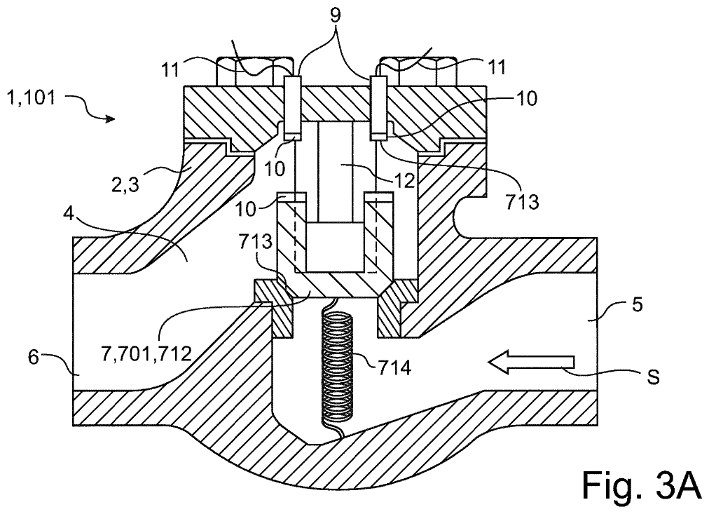

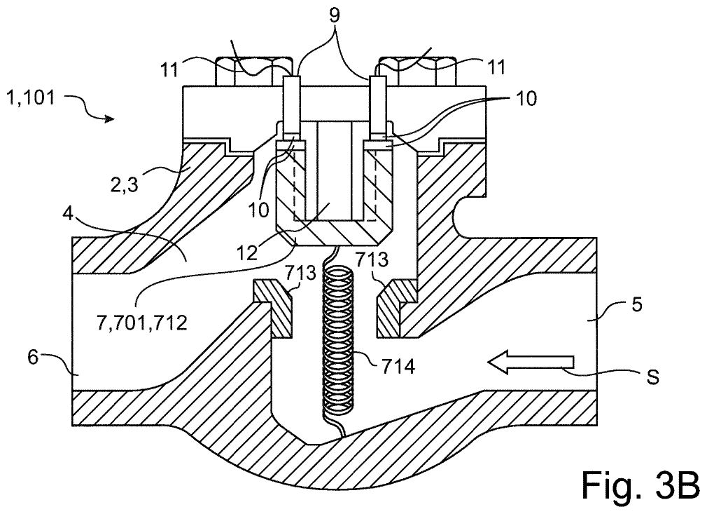

FIG. 3A shows a schematic representation of another embodiment of the sensor according to the invention, which is configured as a valve and shown at the first position of the movable component.

FIG. 3B shows a schematic representation of another embodiment of the sensor according to the invention, which is configured as a valve and shown at the second position of the movable component, which can be achieved via a guided, translatory movement of the movable component.

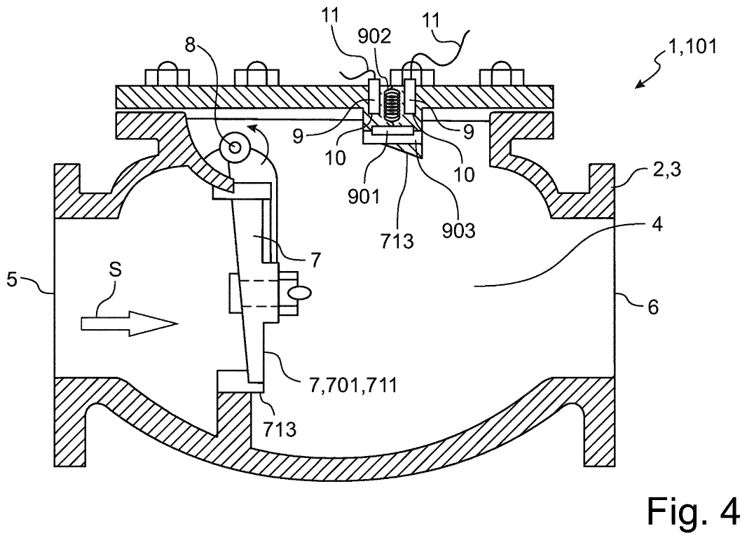

FIG. 4 shows a schematic representation of another embodiment of the sensor according to the invention, which is configured as a check valve and wherein contact of the electrodes by the movable component takes place indirectly;

FIG. 4 shows the first position of the movable component.

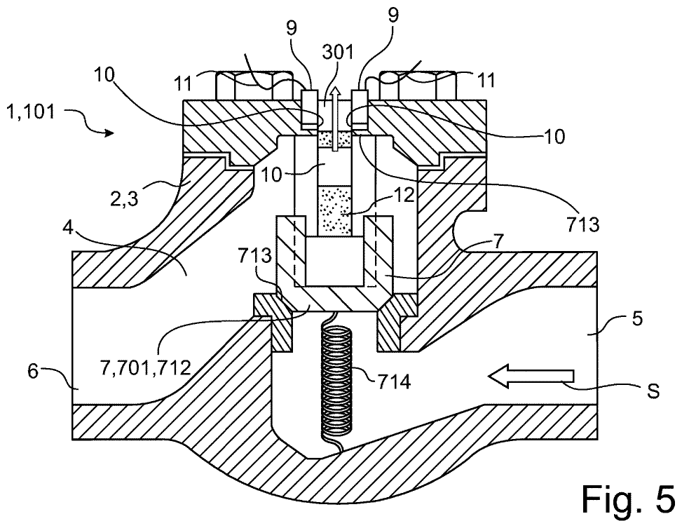

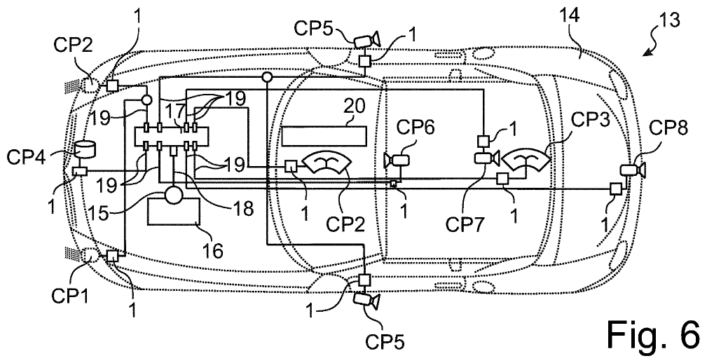

FIG. 5 shows a schematic representation of another embodiment and variant of the sensor according to the invention according to FIGS. 3A and 3B, in which contact of the electrodes takes place within a recess in the housing wall of the sensor. FIG. 5 shows the first position of the movable component.
FIG. 6 shows a schematic representation of a system according to the invention as a fluid distribution system for a motor vehicle.

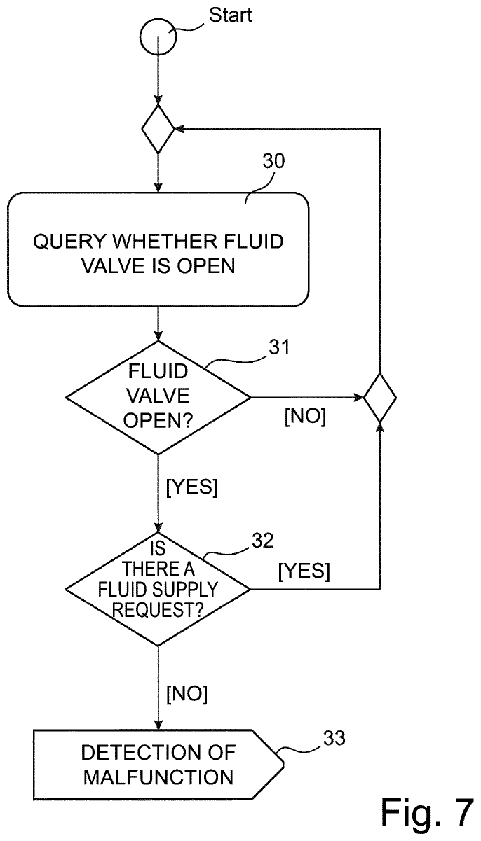

FIG. 7 shows the scheme of a process flow according to a first embodiment of the method according to the invention for detecting a malfunction in a fluid distribution system.

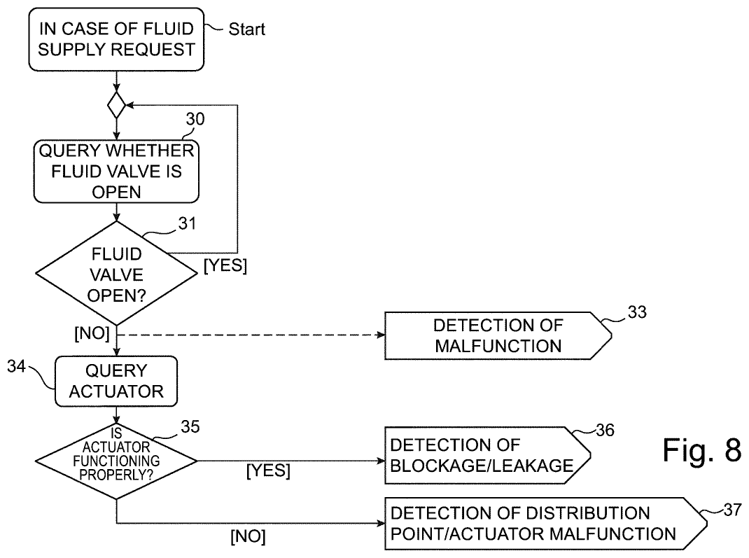

FIG. 8 shows the scheme of a process flow according to another embodiment of the method according to the invention for detecting a malfunction in a fluid distribution system.

In the following description, the same reference signs denote the same components or features, such that a description of a component with reference to one figure also applies to the other figures.

FIGS. 1A and 1B show a first embodiment of the sensor 1 according to the invention for detecting a fluid stream in a fluid line of a motor vehicle, wherein the sensor 1 is configured as a check valve 101, in particular as a unidirectional check valve. The fluid of the fluid stream to be detected is an operating fluid of a motor vehicle, in particular a cleaning fluid.

The sensor 1 has a housing 2 shown in section with a housing wall 3 and encloses the volume/interior 4. One can also see a fluid inlet 5 and a fluid outlet 6. Fluid inlet 5 and fluid outlet 6 are fluidically connected by a fluid channel. The fluid channel extends in the interior 4 of the sensor. Reference sign S, furthermore, designates the fluid stream of the fluid streaming through the fluid channel of the sensor. The flow direction of the fluid stream S substantially runs from the fluid inlet 5 towards the fluid outlet 6, as symbolized by the arrow.

Fluid inlet 5 and fluid outlet 6 are furthermore each connected to a fluid line (not shown).

The movable component 7 is arranged entirely in the interior 4 of the sensor 1 and is configured as a shut-off body 701 or check flap 711 of the check valve 101. The movable component 7 is furthermore connected at the connection point 8, which is also arranged in the interior 4 of the sensor 1, via an axis connection 801 to the housing 2, in particular the inside of the wall of the housing, of the sensor 1. The axis connection of the movable component 7 is located in an end region of the check flap 711. The axis is arranged substantially at a right angle to the flow direction of the fluid stream S, whereby the movable component 7 is rotationally movable about said axis 801. In particular, the movable component 7 is rotationally movable by the fluid stream S from a first position to a second position.

The position of the movable component 7 shown in FIG. 1A corresponds to the first position. The first position of the movable component 7 corresponds to an end position in which the movable component 7 rests against a stop 713 -in this case the valve seat. In the case of the first position of the movable component 7, the stop corresponds to the valve seat of the check valve 101. The first position of the movable component 7 shown in FIG. 1A corresponds to the position in which the valve 101 is closed and/or the electrical circuit of the sensor is open and in which no sensor signal is generated.

The position of the movable component 7 shown in FIG. 1B corresponds to the second position. The second position of the movable component 7 also corresponds to an end position in which the movable component 7 rests against a stop 713. The second position of the movable component 7 shown in FIG. 1B corresponds to the position in which the valve 101 is open. The second position of the movable component shown in FIG. 1B corresponds to the switching position of the sensor 1, in which an electrical circuit is closed, as will be explained in more detail below.

The sensor 1 has two electrodes 9, which are structurally separate from the movable component 7 of the sensor 1. The two electrodes 9 are integrated into the sensor housing 2, in particular its housing wall 3, and point with their metallic and thus electrically conductive contact surfaces 10 in the direction of the interior 4 of the sensor 1. The two contact surfaces 10 of the electrodes 9 are arranged in the interior 4 of the sensor such that they lie substantially outside the fluid stream S. Furthermore, when the valve is open, they are protected from the fluid by the abutting movable component 7 (cf. FIG. 1B). Both electrodes 9 can be electrically contacted via a special cable 11 outside the housing. The electrodes 9 are in particular electrically connected to an ECU (not shown) of a motor vehicle.

The movable component 7 of the sensor 1 also has a metallic and thus electrically conductive contact surface 10, which is arranged on the side of the shut-off body 701 that is opposite the fluid outlet 6 when the valve 101 is closed. As a result, the contact surface 10 of the movable part 7 is substantially not in contact with the fluid even when the valve 101 is closed.

If the movable component 7 of the sensor 1 is rotated by the fluid stream S from its first position (FIG. 1A) to its second position, i.e., the switching position (FIG. 1B), the contact surface 10 of the movable component 7 contacts the two contact surfaces 10 of the electrodes 9, whereby the electrodes 9 are electrically contacted, and the electrical circuit is closed or a sensor signal is generated.

The sensor 1 thus allows for a reliable detection of a fluid stream S flowing through the fluid channel of the sensor 1.

FIGS. 2A and 2B show a second embodiment of the sensor 1 according to the invention for detecting a fluid stream in a fluid line of a motor vehicle. The position of the movable component 7 shown in FIG. 2A corresponds to the first position. The position of the movable component 7 shown in FIG. 2B corresponds to the second position. Hereafter, only the differences from the embodiment shown in FIGS. 1A and 1B will be discussed. All other features, which will not be discussed again, correspond to the first embodiment.

The movable component 7 of the sensor 1 has a metallic and thus electrically conductive contact surface 10, which is arranged in the region of the axis connection 8 of the check flap 711 with the sensor housing 2. The axis connection is arranged in an end region of the check flap 711. The region of the axis connection is furthermore arranged in the fluid-free sub-volume 41 of the sensor such that said region is substantially outside the fluid stream of the fluid and is furthermore protected from the fluid. The wall of the fluid-free sub-volume 41 further has an opening in the form of a slot, sealed against the fluid, through which the movable component 7 extends. The rotational movement of the movable component 7 results in electrical contact being made between its contact surface 10 and the contact surfaces 10 of the two electrodes 9. This closes an electrical circuit and generates a sensor signal. The electrodes 9 are integrated into the housing wall 3, and the contact surfaces 10 of the electrodes protrude into the fluid-free sub-volume 41 of the sensor housing.

The sensor 1 thus allows for a reliable detection of a fluid stream S flowing through the fluid channel of the sensor 1.

FIGS. 3A and 3B show another embodiment of the sensor 1 according to the invention for detecting a fluid stream in a fluid line of a motor vehicle, wherein the sensor 1 is configured again as a valve 101. The fluid of the fluid stream to be detected is compressed air, in particular for cleaning the sensor surfaces of a motor vehicle.

The sensor 1 has a housing 2 shown in section with a housing wall 3 and encloses the volume/interior 4. One can also see a fluid inlet 5 and a fluid outlet 6. Fluid inlet 5 and fluid outlet 6 are fluidically connected by a fluid channel. The fluid channel extends in the interior 4 of the sensor. Reference sign S, furthermore, designates the fluid stream of the fluid streaming through the fluid channel of the sensor. The flow direction of the fluid stream S substantially runs from the fluid inlet 5 towards the fluid outlet 6, as symbolized by the arrow.

Fluid inlet 5 and fluid outlet 6 are furthermore each connected to a fluid line (not shown).

The movable component 7 is arranged entirely in the interior 4 of the sensor 1 and is configured as a shut-off body 701 or cylinder or piston 712 of the check valve 101. The translatorily movable component 7 is furthermore connected to the housing wall 3 of the sensor 1 via the spring 714 and is guided by the guide 12 when transitioning from its first position (FIG. 3A) to its second position (FIG. 3B). The guide 12 is in turn connected to the housing 2 of the sensor 1. The translatory movement of the movable component takes place in a direction of movement which is arranged substantially at a right angle to the flow direction S of the fluid through the flow channel.

The position of the movable component 7 shown in FIG. 3A corresponds to the first position. The first position of the movable component 7 corresponds to an end position in which the movable component 7 rests against a stop. In the case of the first position of the movable component 7, the stop corresponds to the valve seat 713 of the valve 101. The first position of the movable component 7 shown in FIG. 3A corresponds to the position in which the valve 101 is closed and/or the electrical circuit of the sensor is open and in which no sensor signal is generated.

The position of the movable component 7 shown in FIG. 3B corresponds to the second position. The second position of the movable component 7 also corresponds to an end position in which the movable component 7 rests against a stop formed by the two electrodes 9. The second position of the movable component 7 shown in FIG. 3B corresponds to the position in which the valve 101 is open. The second position of the movable component shown in FIG. 3B corresponds to the switching position of the sensor 1, in which an electrical circuit is closed.

The sensor 1 has two electrodes 9, which are structurally separate from the movable component 7 of the sensor 1. The two electrodes 9 are connected to the sensor housing 2, in particular the housing wall 3, and protrude with their metallic and thus electrically conductive contact surfaces 10 into the interior 4 of the sensor 1. The two contact surfaces 10 of the electrodes 9 are arranged in the interior 4 of the sensor such that they lie substantially outside the fluid stream S. Both electrodes 9 can be electrically contacted via a special cable 11 outside the housing. The electrodes 9 are in particular electrically connected to an ECU (not shown) of a motor vehicle.

The movable component 7 of the sensor 1 also has a metallic and thus electrically conductive contact surface 10, which is arranged on the side of the shut-off body 701, which, when the valve 101 is closed, is arranged on the side of the shut-off body, which, along the flow direction S of the fluid, is arranged closer to the fluid outlet 6 than to the fluid inlet 5. The electrically conductive contact surface 10 of the shut-off body 701 has the shape of a ring which is arranged in an end region of the shut-off body 701 which is opposite the valve seat. This allows the two electrodes 9 to be reliably contacted.

If the movable component 7 of the sensor 1 is translatorily moved or raised by the fluid stream S from its first position (FIG. 3A) into its second position, i.e., the switching position (FIG. 3B), the contact surface 10 of the movable component 7 contacts the two contact surfaces 10 of the electrodes 9, whereby the electrodes 9 are electrically contacted, and the electrical circuit is closed or a sensor signal is generated.

The sensor 1 thus allows for a reliable detection of a fluid stream S flowing through the fluid channel of the sensor 1.

FIG. 4 shows a schematic representation of another embodiment and variant of the sensor according to the invention of FIGS. 1A and 1B. In this variant, contact of the electrodes 9 by the movable component 7 takes place indirectly via the contact device 901. Hereafter, only the differences from FIGS. 1A and 1B will be discussed, wherein only the open position of the valve is shown.

The contact device 901 can be seen, which consists of an electrically conductive material and which, together with the electrodes 9, is protected from contact with the fluid by the encapsulation 903. The contact device 903 is further connected to the housing wall 3 of the sensor via the spring 902 and is spring-biased.

In the open state of the sensor/valve shown, the spring force of the spring 902 prevents the electrodes 9 from being contacted by the contact device 901. In the closed state of the sensor/valve (not shown), the contact of the movable component 7 causes the contact device 901 to be brought into contact with the electrodes 9 against the spring force of the spring 902, thereby closing the electrical circuit.

As can also be seen, the contact device 901 encapsulated together with the electrodes 9 is at least partially arranged in the interior 4 of the sensor 1.

FIG. 5 shows a schematic representation of another embodiment and variant of the sensor according to the invention according to FIGS. 3A and 3B. In this variant, the electrically conductive contact surface 10 of the movable component 7 engages in a recess 301 of the housing wall to ensure contact of the electrodes 9. Hereafter, only the differences from FIGS. 3A and 3B will be discussed, wherein only the open position of the valve is shown.

One can see the electrodes 9 that are integrated into the housing wall 3 of the sensor. A recess 301 in the housing wall can also be seen between the sensors 9. The movable component 7 engages in this recess 301 with a region on which the electrically conductive contact surface 10 is arranged. Advantageously, the movable component 7 already in its first position engages in the recess 301, but without the electrically conductive contact surface 10 of the movable component contacting the electrodes 9. This provides guidance of the movable component 7.

When the movable component 7 is raised from the first to the second position by the fluid stream S, it engages deeper into the recess 301. It engages into the recess 301 so deeply that the electrically conductive contact surface 10 of the movable component contacts the electrically conductive contact surfaces 10 of the electrodes 9, thereby closing the electrical circuit.

FIG. 6 shows a schematic representation of a fluid distribution system 13 according to the invention of a motor vehicle 14. The fluid distribution system 13 has a fluid supply device 15 in the form of a pump, which is fluidically connected to a detergent tank 16. The fluid supply device 15 further has a fluid distribution unit 17 in the form of a valve block, wherein the fluid supply device 15 is fluidically connected to the fluid distribution unit 17 via the supply line 18. The supply line 18 is, in particular, connected to the fluid inlet of the fluid distribution unit 17. The fluid supply device 15 is configured to generate a fluid stream of the fluid from the tank 16 in the direction of the fluid distribution unit 17.

Several fluid lines 19 are connected to the individual, controllable fluid outlets of the fluid distribution unit 17 via their respective inlet openings, which fluid lines route the fluid stream generated by the fluid supply device 15 in the direction of at least one outlet opening and to the distribution points CP1-CP8 fluidically connected thereto, in particular to the cleaning points of the motor vehicle.

The fluid distribution unit 17 is thus arranged between the fluid supply device 15 and the inlet opening of the fluid lines 19.

For the purpose of control, the fluid distribution unit 17 is connected to the computing unit 20, which is configured as an ECU of the motor vehicle. The computing unit 20 is further connected to the fluid supply device 15 for the purpose of controlling the same. The computing unit 20 is further configured to generate, evaluate, and/or send a fluid supply request to the fluid supply device. The computing unit 20 is further connected to a switch (not shown) which can be actuated by the user of the motor vehicle to generate a fluid supply request. The computing unit 20 is further configured to generate a fluid supply request based upon the presence of certain operating parameters of the motor vehicle.

The distribution points CP1-CP8 are cleaning points for cleaning the headlights (CP1), the windshield (CP2), the rear window (CP3), the LIDAR (CP4), the side mirrors (CP5), a forward-facing camera (CP6), a rear-facing camera (CP7), and a rear-facing camera in the region of the bumper of the vehicle (CP8). The system shown in the embodiment thus has a total of 10 distribution points. All of these cleaning points contain actuators, the status of which can be queried. The actuators are connected to the computing unit 20 for querying the status.

The fluid distribution system 13 further has several sensors 1 according to the invention for detecting the fluid stream in the fluid lines 19. The sensors are fluid valves for fluids, especially cleaning fluids. The sensors 1 are arranged in the fluid lines 19. The fluid inlet 5 of the sensor 1 is connected to the outlet opening of a first segment of the fluid line 19, and the fluid outlet 6 of the sensor 1 is connected to the inlet opening of a second segment of the fluid line 19. The sensors 1 are further arranged in the end regions of the fluid lines 19. The sensors 1 are thus arranged in the region of the outlet openings of the fluid lines 19 and/or in the region of the distribution points CP1-CP8 of the motor vehicle. All of the sensors 1 are connected to the computing unit 20, such that the sensors 1, in particular the switching position of the sensors 1, can be queried and/or processed by the computing unit 20.

FIG. 7 schematically shows the process flow according to a first embodiment of the method according to the invention for detecting a malfunction in a fluid distribution system. The fluid distribution system is the fluid distribution system 13 of the embodiment of FIG. 4. The method according to the invention is carried out by the computing unit 20 of said fluid distribution system 13.

In process step 30, the sensor 1 in at least one fluid line under consideration of the fluid distribution system 13 is queried via the computing unit 20 as to whether the fluid valve is open or whether a fluid stream can be detected in the fluid line under consideration, i.e., for example, whether a sensor signal has been generated by this sensor 1 or can be detected. If such a sensor signal can be detected, the queried sensor 1 is in its switching position in which an electrical circuit is closed, as described above. If the queried sensor 1 is in its switching position, this also means that a fluid stream has been detected in the region of the distribution point (CPx), which is arranged downstream of the sensor 1 in the fluid line 19 along the fluid stream. If the queried sensor 1 is in its switching position, this also means that the fluid valve is open.

In process step 31, a branching takes place based upon the result of the query of the sensor signal.

If no sensor signal could be detected, the fluid valve is closed, or no fluid stream could be detected. The method according to the invention is then repeated cyclically. This means that the method branches back again to process step 30.

Conversely, if a sensor signal could be detected, the fluid valve is open, or a fluid stream could be detected. Then, in process step 32, a further branching takes place based upon the query as to whether a fluid supply request exists for the fluid line 19 under consideration.

In the event that a fluid supply request exists, the fluid stream in the fluid line 19 under consideration is a desired fluid stream. In that case, the method according to the invention is also repeated cyclically, branching back to process step 30 again.

In the event that a fluid supply request does not exist, the fluid stream in the fluid line 19 under consideration is an undesired fluid stream. Such an undesired fluid stream can occur, for example, if there is a fluid leak in the fluid line 19 under consideration, through which fluid escapes. Such an undesired fluid stream can also occur, for example, if the fluid distribution unit 17 has been incorrectly controlled. In that case, in process step 33, a malfunction of the fluid distribution system or a faulty control of the fluid distribution system is detected.

FIG. 8 schematically shows the process flow according to another embodiment of the method according to the invention for detecting a malfunction in a fluid distribution system.

The fluid distribution system is again the fluid distribution system 13 of the embodiment of FIG. 4. The method according to the invention is also carried out by the computing unit 20 of said fluid distribution system 13.

The method according to the invention is carried out when there is a fluid supply request for a fluid line 19 under consideration. It has a process step 30 that is identical to that of the embodiment of FIG. 5. In process step 30, at least the sensor 1 in the fluid line 19 under consideration of the fluid distribution system 13 is queried via the computing unit 20 as to whether the fluid valve is open, i.e., for example, whether a sensor signal has been generated by this sensor 1 or can be detected. If such a sensor signal can be detected, the queried sensor 1 is in its switching position in which an electrical circuit is closed, as described above. If the queried sensor 1 is in its switching position, this also means that a fluid stream has been detected in the region of the distribution point (CPx), which is arranged downstream of the sensor 1 in the fluid line 19 under consideration along the fluid stream. If the queried sensor 1 is in its switching position, this also means that the fluid valve in the fluid line 19 under consideration is open.

In process step 31, a branching takes place based upon the result of the query of the sensor signal.

If a fluid stream could be detected, the method according to the invention is repeated cyclically as long as a fluid supply request exists for the fluid line 19 under consideration. This means that the method can branch back again to process step 30, since the fluid stream in the fluid line under consideration is desired.

Conversely, if no fluid stream could be detected, a status and/or function query of the actuator of the distribution point in the fluid line 19 under consideration is carried out in process step 34. Furthermore, additionally, in optional process step 33, a malfunction of the fluid distribution system or a faulty control of the fluid distribution system can be detected.

In process step 35, a branching takes place based upon the result of the query of the actuator.

If proper functioning of the actuator has been determined, it can be assumed that there is a blockage and/or leakage in the fluid line 19 under consideration. In that case, in process step 36, a blockage and/or leakage in the fluid line is determined or detected.

If the actuator is not found to be functioning properly or is malfunctioning, it can be assumed that the distribution point and/or the actuator is malfunctioning. In that case, in process step 37, a malfunction of the distribution point and/or the actuator in the fluid line is determined or detected. Together with each or both of process steps 36 and 37, a malfunction of the fluid distribution system after process step 33 can also be determined or detected.

### LIST OF REFERENCE SIGNS

1 sensor
2 housing, sensor housing
3 housing wall of the sensor
4 volume/interior of the sensor
5 fluid inlet
6 fluid outlet
7 movable component of the sensor
8 connection point of the movable component with the housing
9 electrode
10 contact surface of electrode and/or movable part
11 electrical contact of the electrode; single-core cable
12 guide
13 system; fluid distribution system
14 motor vehicle
15 fluid supply device; pump; pump for detergent
16 tank; detergent tank
17 fluid distribution unit; valve block
18 supply line
19 fluid line
20 computing unit; ECU
30 query whether sensor (fluid valve) is open
31 branching based upon query
32 branching based upon the presence of a fluid supply request
33 determination/detection of a malfunction
34 status/function query of the actuator of the distribution point
35 branching based upon the function of the actuator
36 determination/detection of a blockage and/or leakage
37 determination/detection of a malfunction of the distribution point and/or actuator
41 fluid-free sub-volume of the interior of the sensor
101 valve; fluid valve; check valve
301 recess; recess in the housing wall
701 shut-off body of a valve
711 check flap
712 cylinder, piston
713 stop, valve seat
714 spring
801 axis; axis connection of the movable component with sensor housing
901 contact device, metallic contact device
902 spring
903 encapsulation
CPx distribution point; fluid distribution point; cleaning point; fluid receiver
S fluid stream

1. A sensor for detecting a fluid stream in a fluid line, comprising:
a housing including at least one fluid inlet and at least one fluid outlet, wherein the fluid inlet and fluid outlet are fluidically connected to one another by at least one fluid channel; and
at least one movable component which is at least partially arranged in the fluid channel and which can be moved from a first position to a second position by a fluid stream flowing through the fluid channel,
wherein the first position and/or the second position is a switching position in which an electrical circuit is closed.

2. The sensor according to claim 1, wherein the movable component is connected to the housing at least at one point or is not connected to the housing.

3. The sensor according to claim 1, wherein the movable part can be moved translatorily and/or rotationally by the fluid stream.

4. The sensor according to claim 1, wherein the sensor is configured as a fluid valve, and the movable part is the shut-off body of the fluid valve.

5. The sensor according to claim 4, wherein the fluid valve is selected from the group consisting of a check valve, a check valve with a check flap as valve body, a check valve with a ball as valve body, a pressure valve, a unidirectional pressure valve, a bidirectional pressure valve, a unidirectional check valve, and a bidirectional check valve.

6. The sensor according to claim 1, comprising at least two electrodes, wherein the electrodes are contacted in the switching position.

7. The sensor according to claim 1, wherein the movable component has at least one contact surface for closing the electrical circuit and/or for electrical contact of the at least two electrodes.

8. The sensor according to claim 1, wherein at least one electrode is connectable and/or connected to a computing unit.

9. A system for detecting a fluid stream in a fluid line, comprising:
a fluid supply device,
a first fluid line with at least one inlet opening and at least one outlet opening, wherein the first fluid line is fluidically connected to the fluid supply device;
wherein the fluid supply device is suitable for generating a fluid stream from the fluid supply device to the outlet opening of the first fluid line; and
a first sensor for detecting the fluid stream in the first fluid line, wherein the sensor is arranged on and/or at least partially in the first fluid line.

10. The system according to claim 9, wherein the first sensor is a sensor for detecting a fluid stream in a fluid line, comprising:
a housing including at least one fluid inlet and at least one fluid outlet, wherein the fluid inlet and fluid outlet are fluidically connected to one another by at least one fluid channel; and
at least one movable component which is at least partially arranged in the fluid channel and which can be moved from a first position to a second position by a fluid stream flowing through the fluid channel,
wherein the first position and/or the second position is a switching position in which an electrical circuit is closed.

11. The system according to claim 9, comprising:
at least one computing unit, wherein the computing unit is connected to at least the first sensor;
at least a second fluid line with at least one inlet opening and at least one outlet opening, wherein the second fluid line is fluidically connected to the fluid supply device; and
at least one fluid distribution unit which is arranged between the fluid supply device and the inlet opening of the first fluid line, as well as the inlet opening of the second fluid line.

12. A system configured to carry out the method according to claim 9.

13. A method for detecting a malfunction in a fluid distribution system, comprising:
a fluid supply device,
at least a first fluid line with at least one inlet opening and at least one outlet opening, wherein the first fluid line is fluidically connected to the fluid supply device,
wherein the fluid supply device is suitable for generating a fluid stream from the fluid supply device to the outlet opening of the first fluid line, and
a first sensor for detecting the fluid stream in the first fluid line, wherein the sensor is arranged on and/or at least partially in the first fluid line, and
a computing unit, wherein the computing unit is connected to at least the first sensor;
wherein the method includes the steps of:
a1) detecting a fluid stream in the first fluid line by means of the first sensor, and
b1) detecting a malfunction, if
a fluid stream has been detected although there is no fluid supply request for the first fluid line, or
no fluid stream has been detected although there is a fluid supply request for the first fluid line.

14. The method according to claim 13, wherein no fluid stream has been detected although there is a fluid supply request, further comprising the steps of:
b2) detecting the proper functioning of a distribution point at the outlet opening of the first fluid line; and
b3) detecting a blockage and/or a fluid leak in the first fluid line if proper functioning of the distribution point has been detected; or
detecting a malfunction of the distribution point if no proper functioning of the distribution point has been detected.

15. The method according to claim 13, wherein the sensor is a sensor for detecting a fluid stream in a fluid line, comprising:
a housing including at least one fluid inlet and at least one fluid outlet, wherein the fluid inlet and fluid outlet are fluidically connected to one another by at least one fluid channel; and
at least one movable component which is at least partially arranged in the fluid channel and which can be moved from a first position to a second position by a fluid stream flowing through the fluid channel,
wherein the first position and/or the second position is a switching position in which an electrical circuit is closed.

16. A motor vehicle comprising a sensor according to claim 1 and/or a system for detecting a fluid stream in a fluid line, comprising:
a fluid supply device;
a first fluid line with at least one inlet opening and at least one outlet opening, wherein the first fluid line is fluidically connected to the fluid supply device;
wherein the fluid supply device is suitable for generating a fluid stream from the fluid supply device to the outlet opening of the first fluid line;
a first sensor for detecting the fluid stream in the first fluid line, wherein the sensor is arranged on and/or at least partially in the first fluid line; and/or configured to carry out a method for detecting a malfunction in a fluid distribution system, comprising:
a fluid supply device,
at least a first fluid line with at least one inlet opening and at least one outlet opening, wherein the first fluid line is fluidically connected to the fluid supply device,
wherein the fluid supply device is suitable for generating a fluid stream from the fluid supply device to the outlet opening of the first fluid line, and
a first sensor for detecting the fluid stream in the first fluid line, wherein the sensor is arranged on and/or at least partially in the first fluid line,
a computing unit, wherein the computing unit is connected to at least the first sensor;
wherein the method includes the steps of:
a1) detecting a fluid stream in the first fluid line by means of the first sensor, and
b1) detecting a malfunction, if
a fluid stream has been detected although there is no fluid supply request for the first fluid line, or
no fluid stream has been detected although there is a fluid supply request for the first fluid line.
